(19) United States
(12) Patent Application Publication
(10) Pub. No.: US 2024/0365840 A1
(43) Pub. Date: Nov. 7, 2024

(54) KIT AND METHOD FOR MAKING MULTI-LAYERED FOOD

(71) Applicant: Elisabeth M. Walburger, Folsom, CA (US)

(72) Inventor: Elisabeth M. Walburger, Folsom, CA (US)

(21) Appl. No.: 18/512,174

(22) Filed: Nov. 17, 2023

Related U.S. Application Data
(60) Provisional application No. 63/499,299, filed on May 1, 2023.

(51) Int. Cl. A23P 20/20; A23P 30/10

(52) U.S. Cl. CPC A23P 20/20; A23P 30/10

(57) ABSTRACT

A kit for creating multi-layered food may include a core mold with one or more core cavities, where each core cavity may receive an inside layer material or filling. The kit may also include a shell mold with one or more shell cavities, where each shell cavity may receive a shell material and at least one food core produced from the core mold. Either or both molds may include a flexible material. The kit may also include a support tray to provide structural support to the molds; a tool for compressing and smoothing the inside layer material, filling, and shell material; and a lid. Also, a method for creating multi-layered food where a core mold may be used to create a food core from an inside layer material or filling, and a shell mold may be used to encase the filling with a shell material.

### CROSS-REFERENCE TO RELATED APPLICATIONS

This application claims the benefit under 35 U.S.C. 119 (e) of U.S. Provisional Application No. 63/499,299 filed May 1, 2023, which is hereby incorporated by reference.

### STATEMENT REGARDING FEDERALLY SPONSORED RESEARCH AND DEVELOPMENT

Not applicable.

### THE NAMES OF THE PARTIES TO A JOINT RESEARCH AGREEMENT

Not applicable.

### STATEMENT REGARDING PRIOR DISCLOSURES BY THE INVENTOR OR A JOINT INVENTOR

Not applicable.

### BACKGROUND OF THE INVENTION

The invention relates generally to culinary equipment and processes for making food products, and more particularly to baking equipment and processes for making multi-layered food and baked goods with an inside layer material surrounded by a shell.

### BRIEF SUMMARY OF THE INVENTION

The present disclosure extends to devices, kits, systems, assemblies, apparatuses, and methods for creating multi-layered food. Such are configured to, for example, allow a skilled artisan to create multi-layered food with a cake core and a chocolate shell.

According to one aspect of the present disclosure, one embodiment of this teaching includes a kit for creating a multi-layered food, according to principles described herein. The kit includes a core mold, a shell mold, a support tray, and a tool for compressing and smoothing. The core mold includes one or more core cavities, and the shell mold includes one or more shell cavities.

The kit may include two or more molds that are configured to nest within each other. In some examples, the core cavities of a core mold are dimensioned to nest within the shell cavities of a shell mold. Some examples of these molds may achieve such nesting through an arrangement of nesting one core cavity within each shell cavity.

In some examples, the kit may also include one or more lids. In one example, a lid may be configured to cover the core mold alone, the shell mold alone, or both molds together. In another example, a lid may be configured to attach to the rim of the core mold, the rim of the shell mold, and/or the rim of the support tray. In a further example, a lid may be configured to attach to the rim of a single core cavity or the rim a single shell cavity. In yet another example, a lid may be configured to cover each core cavity or each shell cavity independently of one another. In still other examples, the lid may include one or more handles on the top or sides of the lid, such that when the lid is attached to the core mold, the shell mold, or the support tray, the user can lift the lid and any attached kit pieces by using the handle.

In addition to the kit, at least one example of the method includes preparing an inside layer material or filling. The inside layer material may be cake, cookie, brownie, a protein mix, an energy mix, cookie mix, brownie mix, a low-carb high-fat mix, or another similar suitable inside layer material. In some examples, the preparation of the inside layer material may include baking a cake and then crumbling the baked cake into crumbs. Another example may include preparing a mix including an ingredient with a high concentration of protein. In other examples, the inside layer material may be candy.

In addition to the method for preparing an inside layer material of filling, this disclosure provides a method for preparing a shell material. By way of example, this shell material may be chocolate, frosting, custard, yogurt, or another suitable material for creating an edible shell. In some examples, the shell material may include contents, such as food coloring, that produce various pleasing colors or color patterns. In other examples, the shell material may include a mixture of confectionary sprinkles, nuts, and/or coconut.

The skilled artisan would understand that unlike many conventional methods for adding layers to food products, many examples of the method described above do not require the user to seal the contents of the core mold and shell mold into the molds. In some examples, the need for sealing is replaced by using the tool configured to compress and smooth the contents of the cavities, which enables the user to fill a mold to capacity, compress the contents of the mold, and smooth the top surface of the contents of the mold. In many examples, no additional sealing apparatus is required during cooling or setting.

At least one example of the method includes preparing a shell material. This shell material may be chocolate, frosting, custard, yogurt, or another suitable material for creating an edible shell. In some examples, the shell material may include contents, such as food coloring, that produce various pleasing colors or color patterns. In other examples, the shell material may include a mixture of confectionary sprinkles, nuts, and/or coconut.

Then, in some examples of the method, a portion of the prepared shell material is placed into a shell cavity of a shell mold. In some examples, shell material is added to the shell cavity until it reaches a mark on the shell cavity or a measuring tool indicating a proper volume. In one example, shell material is added to the shell cavity until the shell cavity is one-third full. Also, in some examples, the shell mold or shell cavity may be tapped to release air bubbles from the shell material and to spread the shell material evenly in the cavity. This tapping may be performed by lightly striking the shell mold or shell cavity multiple times with a finger or hand, or a tool or utensil may be employed to strike the mold or cavity.

Next, in some examples of the method, at least one food core may be placed in the shell cavity. In other examples, the food core may be placed in the shell cavity first, and then the shell material added around it. The food core may then be pressed into the shell material such that the shell material begins to surround the food core. As noted above, the sides and/or bottom surface of the shell cavity of some examples may include a pattern or lettering that is imparted on the sides or bottom of the shell material. In some examples, the shell mold or shell cavity may be tapped to release air bubbles from the shell material surrounding the food core and to spread the shell material evenly around the food core. This tapping may be performed by lightly striking the shell mold or shell cavity multiple times with a finger or hand, or a tool or utensil may be employed to strike the mold or cavity.

According to another aspect of the present disclosure, in some examples of the method, additional shell material may then be added to the shell cavity. For example, additional shell material may be added to the top of the food core or injected into the sides or bottom of the shell cavity. Additional tapping may be required to release newly formed air bubbles or to re-position the food core after adding additional shell material.

Then, in some examples of the method, excess shell material is removed from the top opening of the shell cavity. In some examples, a tool configured to smooth the top surface of the shell material in the shell cavity is used to produce a flat surface that is flush with the top opening of the shell cavity. After smoothing the top surface of the shell material, in some examples, a tool configured with a pattern or lettering may be used to compress the shell material, thus imparting the pattern or lettering onto the surface of the shell material. It should also be noted that this impartation of a pattern or lettering may occur at any point after smoothing the shell material, for example, partially through the time it takes the shell material to set.

Next, in some examples of the method, the shell mold containing the shell material and at least one food core may be left to set. In some examples, this setting may be achieved by chilling the shell mold and its contents. This chilling may be achieved by placing the core mold and its contents in a refrigerator, freezer, or other suitably cold environment. In at least one example of the method, the shell material is kept at a range of 38-40° F. for 5 to 10 minutes. Alternatively, in at least one example, the shell mold may be left at room temperature until the shell material has set.

Finally, in some examples of the method, the contents of each shell cavity may be removed to create one or more completed multi-layered foods. In at least one example, the shell mold is made of a flexible material such that the bottom of each shell cavity may be pressed, the force thus being imparted on the bottom of the multi-layered food and pushing the multi-layered food out of the shell cavity. In other examples, the shell mold and shell cavities may include several pieces that are able to be disassembled, thus allowing the shell cavities to be disassembled and thereby freeing the completed multi-layered food from the mold.

In some examples of the method described above, at one or more points during the implementation of the method, the core mold and/or the shell mold may be placed on a support tray to provide structural support to the mold. It should be appreciated that this structural support may be required to perform more easily one or more of the steps detailed above.

The skilled artisan would understand that unlike many conventional methods for adding layers to food products, many examples of the method described above do not require the user to seal the contents of the core mold and shell mold into the molds. In some examples, the need for sealing is replaced by using the tool configured to compress and smooth the contents of the cavities, which enables the user to fill a mold to capacity, compress the contents of the mold, and smooth the top surface of the contents of the mold. In many examples, no additional sealing apparatus is required during cooling or setting.

The skilled artisan would appreciate that avoiding the need to seal the contents of a mold into the mold makes the method easier to accomplish for less experienced bakers. Various examples of decorated multi-layered foods are shown. In many examples, the completed multi-layered foods are glazed with frostings of one or more colors, topped with chocolate or frosting shapes, topped with sprinkles, drizzled with chocolate, topped with fondant or wafer flowers, given edible stenciling, topped with berries or marshmallows, or otherwise decorated as is suitable for confectionary food. In some examples, the completed multi-layered food (before or after decoration) may be stored in the shell mold, a mold with larger cavities than the shell mold, or on the support tray. Additionally, in some examples, a lid may be placed over the completed multi-layered food and securely fastened to the shell mold or support tray to provide easy and safe transportation and/or storage of the completed multi-layered food.

As disclosed the kit for creating multi-layered food has a core mold, a shell mold, and a support tray, which may all be nested together. Additional examples may also include a lid configured to cover the nested pieces of the kit. Some examples of the kit may include an arrangement of core cavities and shell cavities configured such that the core cavities of the core mold may nest within the shell cavities of the shell mold.

Also, in at least one example, the support tray may include a rim that defines an outer perimeter of the support tray and a flat surface recessed below the rim, the recessed flat surface and rim defining a hollow space with the flat surface dimensioned to receive and support the core mold and/or shell mold. In further examples, the tool may include a raised surface of the same shape as the opening of at least one of the core cavities or shell cavities such that the tool may be placed securely in the respective cavity.

According to another aspect of the disclosure, the lid may be configured such that it attaches to the rim of the support tray while the support tray is supporting the other pieces of the kit, such that all the pieces of the kit are contained within the space created between the support tray and the lid. It should be appreciated that this nesting ability allows for easier storage of the entire kit.

According to yet another aspect of the present disclosure, the core cavities of the core mold are dimensioned to nest within the shell cavities of a shell mold. Some examples of these molds may achieve such nesting through an arrangement of nesting one core cavity within each shell cavity. In other illustrative examples, the volume of each shell cavity may be dimensioned such that multiple core cavities may be nested within a single shell cavity. While nested, in some examples, the outer edges of each core cavity may contact the inner edges of each shell cavity to achieve a snug fit, while in other examples, the edges of the respective cavities may not come into contact to result in a looser fit.

Additionally, in some examples, the core mold and/or the shell mold may each have a top surface that connects the cavities of the mold and a rim defined by the outer perimeter of the top surface. The skilled artisan would understand that in many examples, the top surface and rim are useful for holding and maneuvering the mold. In some examples, the rim causes the outer edges of the mold to be generally rectangular, though in other examples, the arrangement of the mold's cavities may allow the rim to cause the outer edges of the mold to be another shape, for example, a circle. In some examples, the rim of either or both molds may include one or more handles to allow the user to easily grasp and move the mold and its contents.

In some examples, the rim of the core mold and rim of the shell mold may be dimensioned such that when nested, the outer edge of the rims of both molds are flush. Additionally, in some examples, one or both molds may include snaps or other fasteners (or features of their respective rims that act as such), such that the molds may be more securely attached together while nested.

In some examples, the rim of each mold may include at least one tab portion and at least one trimmed portion to assist in separating the core mold from the shell mold when the two molds are nested together. A tab portion may be a flat member that is flush with the top surface of the mold and may extend outward from the perimeter of the top surface. Also, a trimmed portion may be a portion of the perimeter of the flat surface of either mold that is shortened relative to the surrounding rim or relative to a tab portion of the other mold. In some such examples, a tab portion of one mold may overlap with a trimmed portion of the other mold when the molds are nested. These tab portions, especially when combined with an overlapping trimmed portion, create a location on the rim of each mold that is easy for the user to grasp. This may assist the user to separate the molds after they have been nested.

According to another embodiment, the rim of the core mold may have a tab portion on the upper left and lower right corners, and a trimmed portion on the upper right and lower left corners. The shell mold may then have a tab portion on the upper right and lower left corners, and a trimmed portion on the upper left and lower right corners. It should be appreciated that when the two molds are nested together, the tab portions allow the user to easily grasp each mold individually and thereby separate them.

According to yet another aspect of the present disclosure, the core cavity is configured to receive an inside layer material or filling to form a food core. In some examples, the core cavities are each defined by a shaped depression or other type of recess below the top surface of the core mold. For example, the shaped depression in the core mold may be a cylinder with a circular bottom surface and sides perpendicular to the bottom surface. In other examples, the shape of each core cavity may be a cube, a star, a pyramid, arranged in lettering, or any number of other shapes as understood by the skilled artisan.

In some examples, the sides of the depression defining each core cavity need not be perpendicular to the bottom surface but may be arranged at some other angle relative to the bottom surface. The sides and/or bottom surface of the core cavities may also include a pattern or lettering such that the pattern or lettering is imparted onto the inside layer material or filling while it sets in the core mold. In at least one example, all the core cavities of the core mold are the same shape, but it should be appreciated that in some examples the core mold may include core cavities of various shapes. Also, the arrangement and size of the core cavities on the core mold may vary. In some examples, the core cavities may be arranged in rows of equal or unequal numbers, while in other examples the core cavities may be arranged on the core mold in a circular pattern, a square, or some other geometric shape. In one example, the core cavities lay in rows, with each core cavity staggered in between each adjacent core cavity. Some examples may include one or more core cavities of one size, while also including one or more core cavities of a different size.

Similarly, in many examples, each shell cavity is configured to receive a shell material and at least one food core. In some examples, the shell cavities are each defined by a shaped depression or other type of recess below the top surface of the shell mold. For example, the shaped depression in the shell mold may be a cylinder with a circular bottom surface and sides perpendicular to the bottom surface. In other examples, the shape of each shell cavity may be a cube, a star, a pyramid, arranged in lettering, or any number of other shapes. In some examples, the sides of the depression defining each shell cavity need not be perpendicular to the bottom surface but may be arranged at some other angle relative to the bottom surface. The sides and/or bottom surface of the shell cavities may also include a pattern or lettering such that the pattern or lettering is imparted onto the shell material while it sets in the shell mold.

According to a further aspect of the disclosure, all the shell cavities of the shell mold could be the same shape, but it should be appreciated that the shell mold may include shell cavities of various shapes. Also, the arrangement and size of the shell cavities on the shell mold may vary. The skilled artisan would understand that the shell cavities may be arranged in rows of equal or unequal numbers, while in other examples the shell cavities may be arranged on the shell mold in a circular pattern, a square, or some other geometric shape. In one embodiment, the shell cavities lay in rows, with each shell cavity staggered in between each adjacent shell cavity. Some embodiments may include one or more shell cavities of one size, while also including one or more shell cavities of a different size.

According to another aspect of the disclosure, the core mold would have a number of core cavities equal to the number of shell cavities in the shell mold. In other embodiments, the number of core cavities and shell cavities may not be equal. For example, the number of core cavities may be double the number of shell cavities, and each shell cavity may be configured to receive a shell material and two food cores of two core cavities. This may be advantageous if the user desires to place more than one type of food core in each shell cavity.

In other embodiments, each core cavity would have a corresponding shell cavity. In such embodiments, the volume of each core cavity is smaller than the volume of its corresponding shell cavity. Additionally, in some examples each core cavity and its corresponding shell cavity have the same shape. In some examples, the volume of the shell cavity may be at least 20% larger than the volume of its corresponding core cavity. More specifically, in some examples it may be at least 50% larger. Indeed, in at least one example, the volume of the shell cavity is 58% larger than the volume of its corresponding core cavity. It should be appreciated that varying the volume of the shell cavity as compared to the volume of the core cavity has a direct impact on the thickness of the shell material surrounding the food core. This may be desirable for fine-tuning the makeup of the completed multi-layer food.

Further, in some embodiments derived from this disclosure, each of the core cavities and shell cavities would include one or more marks or indentations on the sides of the cavity. One such mark may be a line drawn on the inside wall of the cavity. In other examples, a small indentation may be raised from the inside or outside surface of the cavity wall. Such marks or indentations may be placed at a point on the wall of the cavity to indicate the proper amount of inside layer material, filling, or shell material to add to the cavity. For example, a shell cavity may have a mark on the inside surface of the shell cavity indicating the volume of chocolate shell material to add to the shell cavity before placing a food core in the shell cavity.

In other embodiments, a cavity may include multiple marks or indentations, where each mark or indentation indicates the proper volume of a different type of material. For example, a shell cavity may have multiple marks on the inside surface of the shell cavity, where one mark indicates a proper amount of chocolate shell material to add, while another mark indicates a proper amount of yogurt shell material to add. In other examples, various marks may be used to help the user achieve different densities, thicknesses, or ratios of the materials placed in the cavity. In one example, a shell cavity may have multiple marks on the inside surface of the shell cavity, each indicating a different amount of shell material to add before placing a food core in the shell cavity, thus assisting the user in producing various thicknesses of shell material surrounding the food core.

In some embodiments, the marks or indentations would be placed on a separate measuring tool instead of directly on the sides of a cavity. For example, the kit may include a measuring tool having a handle and a slender member extending from the handle, where the slender member may have various marks along its length. When the slender member is placed in a cavity such that it touches the bottom surface of the cavity, the marks may be used to assist the user in adding the proper amount of inside layer material, filling, or shell material to the cavity. The tool may then be removed. It should be appreciated that while placing the marks or indentations directly on the sides of a cavity may, in some examples, result in the mark or indentation imparting its shape on the cavity's contents while they set, using a separate measuring tool may help prevent such unintended impartations because the measuring tool is removed before the contents set.

According to yet another aspect of the present disclosure, the support tray would include a flat surface such that the core mold and/or the shell mold may be placed on the support tray for structural stability. It may also have a rim configured to define the boundaries of the support tray. In some embodiments, the rim may be configured to prevent a mold placed on the support tray from sliding off the support tray. In other embodiments, the rim may be configured to attach to a lid. Also, in some embodiments, the rim may include one or more handles, for example on opposing ends of the tray, to allow the user to easily grasp and move the support tray and its contents. As shown, the tray may be a generally flat, elongate member in the shape of a rectangle with area dimensions that supersede or are equal to the area dimensions of the bottoms of the core mold and shell mold.

According to another aspect of the disclosure, the flat surface of the support tray would include indentations to provide extra stability. For instance, a support tray configured to provide structural support to a shell mold may have a number of indentations in the flat surface equal to the number of shell cavities in the shell mold. Further, the indentations may be of the same shape as the bottom surface of the shell cavities, and each indentation may be dimensioned to receive the bottom surface of a shell cavity. It should be appreciated that such indentations may provide additional stability of the mold and help prevent the mold from sliding on the support tray.

In one embodiment, the compressing and smoothing tool may include a flat surface with a raised portion, with the raised portion being the same shape or generally the same shape as the top opening of one or more of the core cavities and/or shell cavities. The raised portion may be dimensioned such that the raised portion is slightly larger than the top opening of a cavity, thereby allowing the user to easily compress the contents of the cavity to be flush with the top opening, or the raised portion may be dimensioned to be slightly smaller than the top opening, thus allowing the user to easily compress the contents of the cavity to below the top opening. The raised portion may also have tapered sides, thereby allowing the tool to be used to compress the contents of the core cavities and/or shell cavities when a cavity also has tapered sides.

According to another aspect of the present disclosure, the raised portion may define a flat bottom surface dimensioned such that the bottom surface is slightly larger than the top opening of a cavity, thereby allowing the user to easily compress the contents of the cavity to be flush with the top opening, or the bottom surface may be dimensioned to be slightly smaller than the top opening, thus allowing the user to easily compress the contents of the cavity to below the top opening. The tool may also have walls extending upwards from the bottom surface to connect it to a top surface of the tool. The walls may, in some examples, be tapered, thereby allowing the tool to be used to compress the contents of the core cavities and/or shell cavities when a cavity has tapered sides. In some examples, the top surface may include one or more grooves, indentations, or depressions. It should be appreciated that these features may be configured to create a grip for the user and to provide ease of use of the tool. In some examples, the tool may also include a flat surface that extends away from the perimeter of the top surface. This flat surface may extend away from the entire perimeter of the top surface or may only extend from a portion of the perimeter of the top surface. The skilled artisan would understand that this flat surface may be used as an additional gripping feature of the tool or may be used to smooth the contents of the core cavities and/or shell cavities.

According to another aspect of the disclosure, the raised portion may include a pattern or lettering such that the raised portion can be pressed against the contents of a core cavity or shell cavity and impart the pattern or lettering onto the contents of the cavity. Further, in some embodiments, the tool may include one or more handles. Such handles may be configured to allow easy motion of the tool across the top surface of the core cavities or shell cavities as it smooths the contents of the cavity. In some examples, the one or more handles may also be configured to allow the user to easily align the raised portion with a cavity. In other embodiments, the handles may be configured to allow for pressure to be evenly applied across the raised portion when compressing the contents of a cavity.

As noted above, in some embodiments, the tool may include a surface for smoothing the contents of a core cavity or shell cavity across the top opening of the cavity. In at least one embodiment, the flat surface of the tool is configured to perform this smoothing. In other embodiments, the tool may include another means of smoothing, for example, a shaft extending distally from a handle, where the shaft is dimensioned to be of a length equal to or longer than the diameter of a core cavity or shell cavity.

In some examples, the tool may also be capable of compressing or smoothing the contents of multiple core cavities or shell cavities simultaneously. This may be achieved by including a flat surface large enough to smooth the contents of multiple cavities across the top openings of all the cavities simultaneously. In some examples, the tool may include multiple raised portions, each configured with the shape of one of the core cavities or shell cavities, such that the raised portions may be simultaneously aligned with multiple cavities. Force may then be applied across the entire tool to compress the contents of all the affected cavities at once.

While many of the illustrated examples of the kit herein show only one tool, the skilled artisan would understand that any number of similar tools may be included with the kit. For example, the kit may contain two such tools: a first dimensioned appropriately for use with the core mold, and a second dimensioned appropriately for use with the shell mold. Separate tools may also be provided where the compression and smoothing functions are separated between multiple tools.

According to another aspect of the present disclosure, either or both molds could be configured to be flexible. This flexible fabrication would allow a skilled artisan to more easily dispense at least one core from the cavity molds.

The skilled artisan would understand that there are many methods of making the core mold and/or shell mold flexible. In some examples, one or both molds are made of a flexible food-grade silicon material. Some examples may include a material that is tolerant to high or low temperatures to assist the user when using the molds during baking or cooling. For example, a material may be used that allows the cavities of one or both molds to generally retain their size and shape while the contents of the mold are baking or cooling.

The skilled artisan would understand that such tolerance to heat and cold may assist in producing food cores and multi-layered foods with more uniform and consistent sizes and shapes. In another example, a heat- or cold-tolerant material may be used that allows the mold to retain its flexible properties even after repeated baking or cooling. Other examples may include a silicon material that is at least partially resilient to bending, thus allowing the mold to be flexible while still providing a sense of firmness when handling the mold.

According to another aspect of the present disclosure, one or both molds may include multiple sections attached together with snaps or other fastening means (or surface features of the molds that act as such), such that the mold may be disassembled, and the contents easily removed from the cavities.

In yet other exemplary embodiments, the cavities of one or both molds may be made of one material, while the flat surface connecting the cavities together may be made of another material. For example, the cavities may be made of a flexible silicon material to allow the user to easily remove food product from the cavity, while the flat surface of the mold may be made of a rigid metal to provide increased structural support to the mold. Additionally, in some examples it may be advantageous for one mold to be more flexible than the other. For example, it may be advantageous for the core mold to be made of a more flexible material such that the food cores may be easily removed, while the shell mold may be made of a more rigid material such that the shell material sets in a more precise shape.

Examples that include such flexibility address a common user desire for easy removal of the molded food product from the mold after it has set. Without such flexibility, the range of shapes available in which to form food cores and multi-layered food in the molds may be more limited. For example, it may be more difficult to create multi-layered foods with sides perpendicular to their top and bottom surfaces because, without tapered sides, the multi-layered food may be difficult to remove from the mold. A mold that includes a flexible material therefore allows for creating multi-layered foods with such perpendicular sides by providing easy removal from the mold, as well as allowing for more complex shapes than mere cylinders.

According to an additional aspect of the disclosure, at least one example of the method includes preparing an inside layer material or filling. The inside layer material may be cake, cookie, brownie, a protein mix, an energy mix, cookie mix, brownie mix, a low-carb high-fat mix, or another similar suitable inside layer material. In some examples, the preparation of the inside layer material may include baking a cake and then crumbling the baked cake into crumbs. Another example may include preparing a mix including an ingredient with a high concentration of protein. In other examples, the inside layer material may be candy.

According to other aspects of the present disclosure, another method for preparing the inside layer material may also include adding a thickening agent to the inside layer material to form a filling. Some examples may thicken the inside layer material using frosting, custard, cream cheese, coconut oil, almond butter, peanut butter, other nut butter, or another similar suitable thickening agent. This thickening agent may be mixed into the inside layer material by hand, by using an electric mixer, or by other customary mixing means. In some examples, one-fourth to one-half cup of the thickening agent is mixed into the prepared inside layer material. It should be appreciated that varying the ratio of thickening agent to inside layer material may be useful for fine-tuning the makeup and density of the filling. For example, the weight ratio of thickening agent to inside layer material may be 2:5, producing a more lightweight filling, while in other examples, the weight ratio of thickening agent to inside layer material may be 4:5, thus producing a denser filling.

According to another aspect of the present disclosure, a method for using a core mold to mold the inside layer material or filling into a food core is provided. A skilled artisan could place a portion of the prepared inside layer material or filling into a core cavity of a core mold. In some examples, inside layer material or filling is added to the core cavity until it reaches a mark on the core cavity or a measuring tool indicating a proper volume. In one example, three tablespoons of filling are placed in each core cavity. Then, the filling is compressed tightly into the core cavity. In some examples, a tool configured to compress the filling is used. As noted above, the tool of some examples may include a pattern or lettering that is imparted onto the filling during compression. Similarly, the sides and/or bottom surface of the core cavity of some examples may include a pattern or lettering that is imparted on the sides or bottom of the filling during compression.

According to another aspect of the present disclosure, a skilled artisan could remove excess filling from the top opening of the core cavity. In some examples, a tool configured to remove excess material from the top surface of the core mold and shell mold and smooth the top surface of the filling in the core cavity produces a flat surface that is flush with the top opening of the core cavity. After smoothing the top surface of the filling, in some examples, a tool configured with a pattern or lettering may be used to again compress the filling into the core cavity, thus imparting the pattern or lettering onto the top surface of the filling. It should also be noted that this impartation of a pattern or lettering may occur at any point after smoothing the filling and before the filling is surrounded by shell material in a shell cavity, for example, partially through the time it takes to chill or bake the filling.

Alternatively, the method for preparing an inside layer material and the method for using a core mold may be combined by creating an uncooked mix, dough, or batter of suitable inside layer material ingredients, for example, the ingredients to make cake, cookie, brownie, a protein mix, an energy mix, cookie mix, brownie mix, a low-carb high-fat mix, or another similar suitable inside layer material, and then placing the mix, dough, or batter into one or more core cavities of the core mold. In some examples, a tool configured to smooth the top surface of the mix, dough, or batter is used. In these examples, the core mold is made of an oven-safe material, and the core mold is then placed in an oven at a suitable temperature to bake the mix, dough, or batter within the core cavities.

Next, in some examples of the disclosed method, the core mold containing inside layer material or filling in one or more core cavities may be chilled. This chilling may be achieved by placing the core mold and its contents in a refrigerator, freezer, or other suitably cold environment. In at least one example of the method, the filling is kept at a range of 38-40° F. for 45 minutes. In another example of the method, the filling may be frozen for 15 minutes and thereafter refrigerated.

Finally, in some examples of the method, the filling may be removed from each core cavity to create one or more food cores. In at least one example, the core mold is made of a flexible material such that the bottom of each core cavity may be pressed, the force thus being imparted on the bottom of the filling and pushing the filling out of the core cavity to form a food core. In other examples, the core mold and core cavities may include several pieces that are able to be disassembled, thus allowing the core cavities to be disassembled and thereby freeing the filling from the mold to create a food core.

According to another aspect of the present disclosure is a method for using the shell mold. At least one example of the method includes preparing a shell material. This shell material may be chocolate, frosting, custard, yogurt, or another suitable material for creating an edible shell. In some examples, the shell material may include contents, such as food coloring, that produce various pleasing colors or color patterns. In other examples, the shell material may include a mixture of confectionary sprinkles, nuts, and/or coconut.

Then, according to another aspect of the present disclosure, a portion of the prepared shell material is placed into a shell cavity of a shell mold. In some examples, shell material is added to the shell cavity until it reaches a mark on the shell cavity or a measuring tool indicating a proper volume.

According to yet another aspect of the present disclosure, shell material is added to the shell cavity until the shell cavity is at least one-third full. Also, in some variations of the disclosed method, the shell mold or shell cavity may be tapped to release air bubbles from the shell material and to spread the shell material evenly in the cavity. This tapping may be performed by lightly striking the shell mold or shell cavity multiple times with a finger or hand, or a tool or utensil may be employed to strike the mold or cavity.

Next, according to another facet of the present disclosure, at least one food core may be placed in the shell cavity. In other examples, the food core may be placed in the shell cavity first, and then the shell material added around it. The food core may then be pressed into the shell material such that the shell material begins to surround the food core. As noted above, the sides and/or bottom surface of the shell cavity of some examples may include a pattern or lettering that is imparted on the sides or bottom of the shell material. In some examples, the shell mold or shell cavity may be tapped to release air bubbles from the shell material surrounding the food core and to spread the shell material evenly around the food core. This tapping may be performed by lightly striking the shell mold or shell cavity multiple times with a finger or hand, or a tool or utensil may be employed to strike the mold or cavity.

In some examples of the method, additional shell material may then be added to the shell cavity. For example, additional shell material may be added to the top of the food core or injected into the sides or bottom of the shell cavity. Additional tapping may be required to release newly formed air bubbles or to re-position the food core after adding additional shell material.

Then, according to another aspect of the disclosure, excess shell material is removed from the top opening of the shell cavity. In some examples, a tool configured to smooth the top surface of the shell material in the shell cavity is used to produce a flat surface that is flush with the top opening of the shell cavity. After smoothing the top surface of the shell material, in some examples, a tool configured with a pattern or lettering may be used to compress the shell material, thus imparting the pattern or lettering onto the surface of the shell material. It should also be noted that this impartation of a pattern or lettering may occur at any point after smoothing the shell material, for example, partially through the time it takes the shell material to set.

Next, according to some variants of the disclosed method, the shell mold containing the shell material and at least one food core may be left to set. In some examples, this setting may be achieved by chilling the shell mold and its contents. This chilling may be achieved by placing the core mold and its contents in a refrigerator, freezer, or other suitably cold environment. In at least one example of the method, the shell material is kept at a range of 38-40° F. for 5 to 10 minutes. Alternatively, in at least one example, the shell mold may be left at room temperature until the shell material has set.

Finally, in some examples of the method, the contents of each shell cavity may be removed to create one or more completed multi-layered foods. In at least one example, the shell mold is made of a flexible material such that the bottom of each shell cavity may be pressed, the force thus being imparted on the bottom of the multi-layered food and pushing the multi-layered food out of the shell cavity. In other examples, the shell mold and shell cavities may include several pieces that are able to be disassembled, thus allowing the shell cavities to be disassembled and thereby freeing the completed multi-layered food from the mold. One example of a completed multi-layered food, after removal from the shell mold.

In some examples of the method described above, at one or more points during the implementation of the method, the core mold and/or the shell mold may be placed on a support tray to provide structural support to the mold. It should be appreciated that this structural support may be required to perform more easily one or more of the steps detailed above.

It should be noted that unlike many conventional methods for adding layers to food products, many examples of the method described above do not require the user to seal the contents of the core mold and shell mold into the molds. In some examples, the need for sealing is replaced by using the tool configured to compress and smooth the contents of the cavities, which enables the user to fill a mold to capacity, compress the contents of the mold, and smooth the top surface of the contents of the mold. In many examples, no additional sealing apparatus is required during cooling or setting. The skilled artisan would understand that avoiding the need to seal the contents of a mold into the mold makes the method easier to accomplish for less experienced bakers.

Referring to another aspect of the present disclosure, the completed multi-layered foods are glazed with frostings of one or more colors, topped with chocolate or frosting shapes, topped with sprinkles, drizzled with chocolate, topped with fondant or wafer flowers, given edible stenciling, topped with berries or marshmallows, or otherwise decorated as is suitable for confectionary food. In some examples, the completed multi-layered food (before or after decoration) may be stored in the shell mold, a mold with larger cavities than the shell mold, or on the support tray. Additionally, in some examples, a lid may be placed over the completed multi-layered food and securely fastened to the shell mold or support tray to provide easy and safe transportation and/or storage of the completed multi-layered food.

The descriptions of the various examples of the present invention have been presented for purposes of illustration but are not intended to be exhaustive or limited to the examples or embodiments disclosed.

### BRIEF DESCRIPTION OF THE SEVERAL VIEWS OF THE DRAWINGS

For a fuller understanding of the nature and advantages of the present apparatus and method, reference should be had to the following detailed description taken in connection with the accompanying drawings, in which:

FIG. 1 illustrates an example of a kit for making multi-layered food.

FIG. 2 illustrates an example of a kit for making multi-layered food, with the kit pieces nested together.

FIG. 3 illustrates an isometric cutaway view of an example of a core mold and a shell mold, with the molds nested together.

FIG. 4 illustrates a side view cutaway of an example of a core mold and a shell mold, with the molds nested together.

FIG. 5 illustrates an isometric cutaway view of an example of a core mold and a shell mold, with the molds nested together.

FIG. 6 illustrates a side view cutaway of an example of a core mold and a shell mold, with the molds nested together.

FIG. 7 illustrates a top view of an example of a core mold and a shell mold, with the molds nested together.

FIG. 8 illustrates a bottom view of an example of a core mold and a shell mold, with the molds nested together.

FIG. 9 illustrates an isometric top view of examples of a core mold and a shell mold.

FIG. 10 illustrates an isometric bottom view of examples of a core mold and a shell mold.

FIG. 11 illustrates a side view of examples of a core mold and a shell mold.

FIG. 12 illustrates a side view of examples of a core mold and a shell mold.

FIG. 13 illustrates an isometric view of an example of a support tray.

FIG. 14 illustrates a top view of an example of a support tray.

FIG. 15 illustrates an example of a smoothing and compression tool.

FIG. 16 illustrates an isometric top view of an example flexible core mold and flexible shell mold.

FIG. 17 illustrates an isometric bottom view of an example flexible core mold and flexible shell mold.

FIG. 18 illustrates a top view of an example flexible core mold and a flexible shell mold.

FIG. 19 illustrates a bottom view of an example flexible core mold and a flexible shell mold.

FIG. 20 illustrates a side view of an example flexible core mold and a flexible shell mold.

FIG. 21 is a flowchart of an example method for preparing an inside layer material or filling.

FIG. 22 is a flowchart of an example method for using a core mold to produce a food core.

FIG. 23 is a flowchart of an example method for using a shell mold to produce a multi-layer food.

FIG. 24 is a flowchart of an example method for preparing a multi-layered food.

The drawings will be described in greater detail below.

### DETAILED DESCRIPTION OF THE INVENTION

While the apparatus, system, and method have been described with reference to various embodiments, those skilled in the art will understand that various changes may be made, and equivalents may be substituted for elements thereof, without departing from the scope and essence of the disclosure. In addition, many modifications may be made to adapt a particular situation or material in accordance with the teachings of the disclosure without departing from the essential scope thereof. Therefore, it is intended that the disclosure is not limited to the embodiments disclosed, but that the disclosure will include all embodiments falling within the scope of the appended claims. In this application all units are in the metric system and all amounts and percentages are by weight, unless otherwise expressly indicated. Also, all citations referred to herein are expressly incorporated herein by reference.

The present invention extends to devices, kits, systems, assemblies, apparatuses, and methods for creating multi-layered food. Such are configured to, for example, allow a skilled artisan to create multi-layered food with a cake core and a chocolate shell.

Reference will now be made to the drawings to describe various aspects of examples of the invention. It is understood that the drawings are diagrammatic and schematic representations of such examples, and are not limiting of the present invention, nor are any elements to be considered essential for all examples or that elements be assembled or manufactured in any order or manner. No inference should therefore be drawn from the drawings as to the necessity of any element. In the following description, numerous specific details are set forth to provide a thorough understanding of the present invention. It will be obvious, however, to one of ordinary skill in the art, that the present invention may be practiced without these specific details. In other cases, well known aspects of baking equipment and methods, and general culinary techniques, are not described in detail herein to avoid unnecessarily obscuring the novel aspects of the present invention.

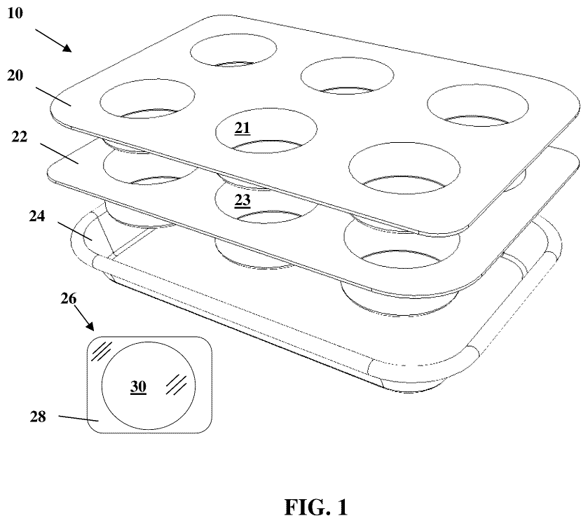

Referring first to FIG. 1, a kit 10 for creating a multi-layered food is shown, according to principles described herein. The kit 10 comprises a core mold 20, a shell mold 22, a support tray 24, and a compressing and smoothing tool 26 for compressing and smoothing. The core mold 20 includes one or more core cavities 21, and the shell mold 22 includes one or more shell cavities 23. In addition, the compressing and smoothing tool 26 has a flat portion 28 and a raised portion 30.

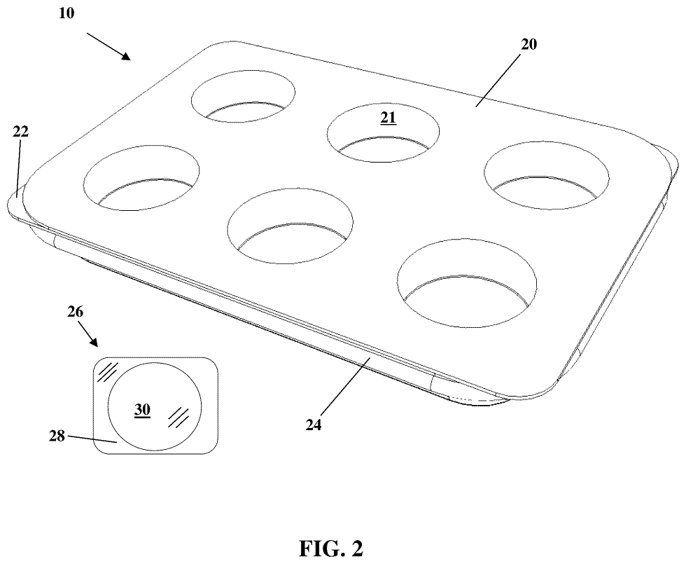

FIG. 2 illustrates the kit 10 for creating multi-layered food where the core mold 20, the shell mold 22, the support tray 24 may be nested together. In addition, the compressing and smoothing tool 26 is shown separate from the nested molds 20 and 22 and the support tray 24.

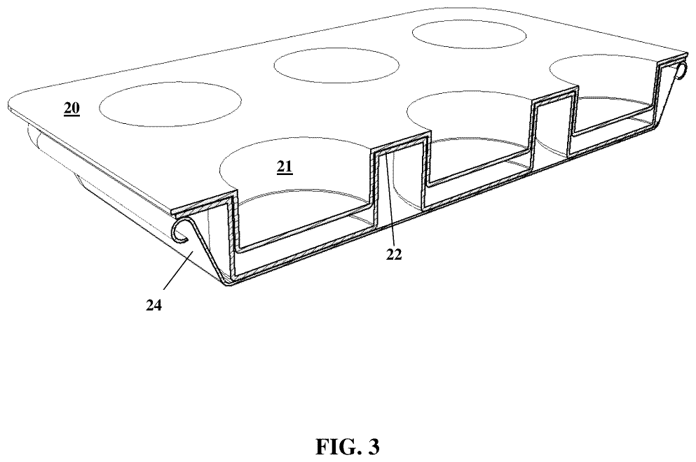

FIG. 3 illustrates the core mold 20 and the shell mold 22, with the molds 20 and 22 nested together. In addition, these nested molds 20 and 22 are stationed on the support tray 24. Also, the core cavity 21 is shown in the core cold 20.

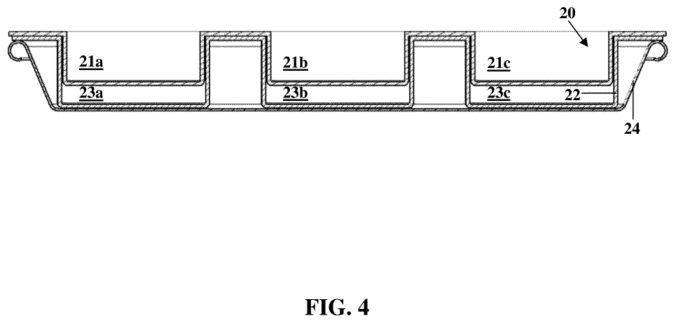

FIG. 4 illustrates a side view cutaway of the core mold 20 and the shell mold 22, with the molds 20 and 22 nested together. Also, these nested molds 20 and 22 are stationed on the support tray 24. The core mold 20 has several core cavities 21a, 21b, and 21c. These core cavities 21a, 21b, and 21c are nested in shell cavities 23a, 23b, and 23c, respectively.

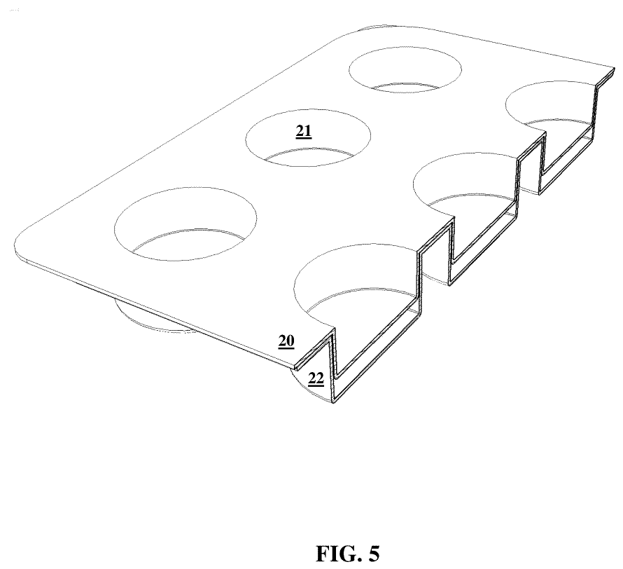

FIG. 5 illustrates an isometric cutaway view of the core mold 20 and the shell mold 22, with the molds 20 and 22 nested together. In addition, the core mold 20 has a core cavity 21.

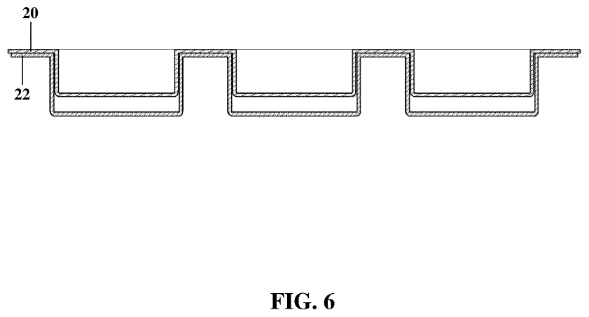

FIG. 6 illustrates a side view cutaway of the core mold 20 and the shell mold 22, with the molds 20 and 22 nested together.

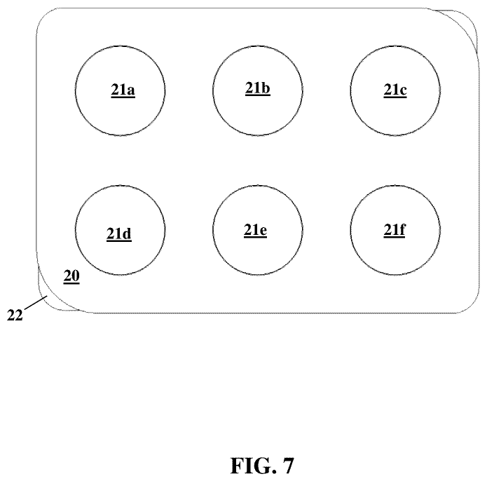

FIG. 7 illustrates a top view of the core mold 20 and the shell mold 22, with the molds 20 and 22 nested together. The core mold 20 has six core cavities 21a, 21b, 21c, 21d, 21e, and 21f.

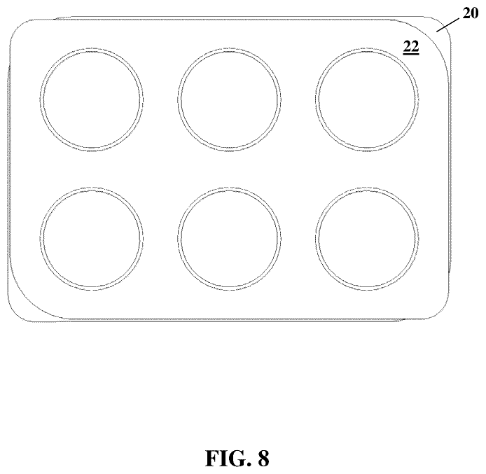

FIG. 8 illustrates a bottom view of the core mold 20 and the shell mold 22, with the molds 20 and 22 nested together.

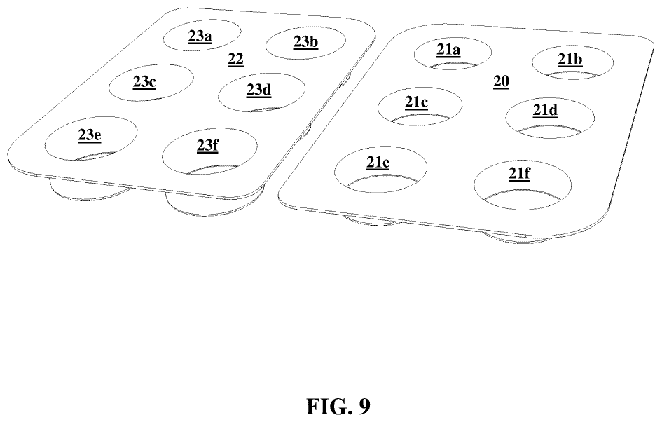

FIG. 9 illustrates an isometric top view of the core mold 20 and the shell mold 22 in an adjacent configuration. The core mold 20 has six core cavities 21a, 21b, 21c, 21d, 21e, and 21f. The shell mold 22 has six shell cavities 23a, 23b, 23c, 23d, 23e, and 23f.

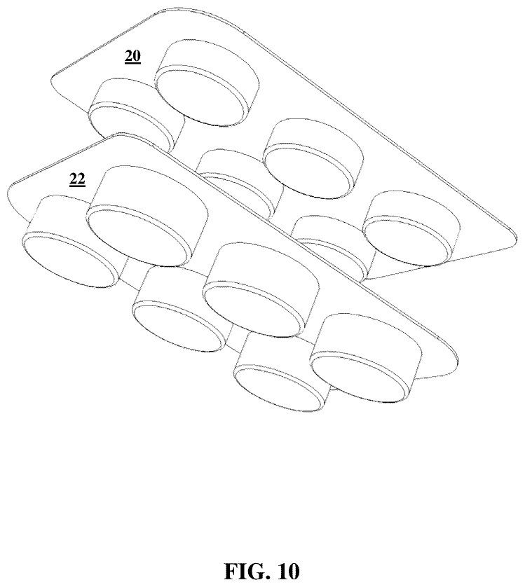

FIG. 10 illustrates an isometric bottom view of the core mold 20 and the shell mold 22.

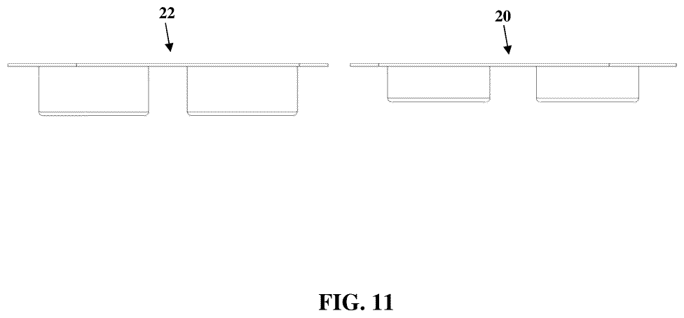

FIG. 11 illustrates a side view of the core mold 20 and the shell mold 22.

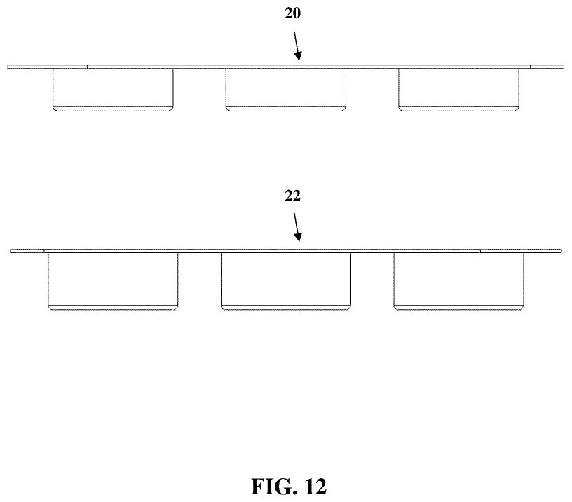

FIG. 12 illustrates another side view of the core mold 20 and the shell mold 22.

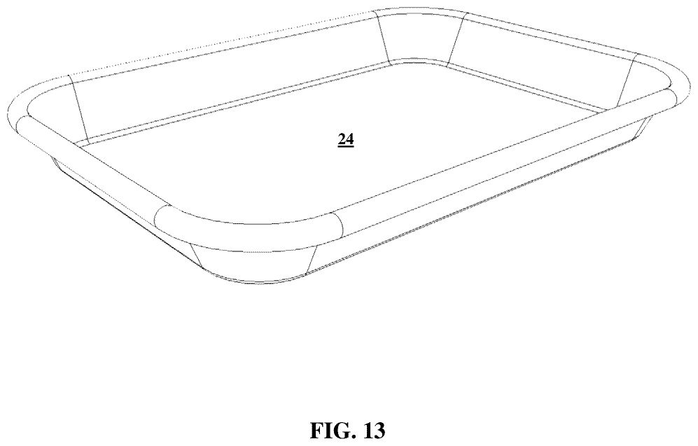

FIG. 13 illustrates an isometric view of the support tray 24.

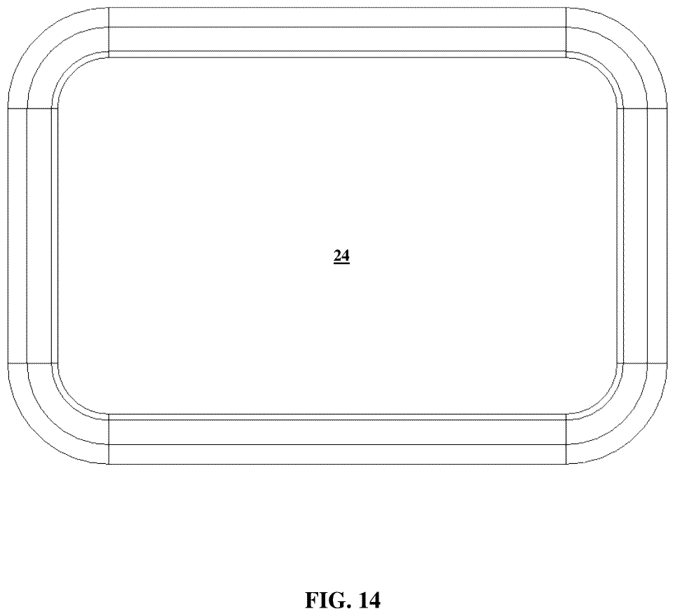

FIG. 14 illustrates a top view of the support tray 24.

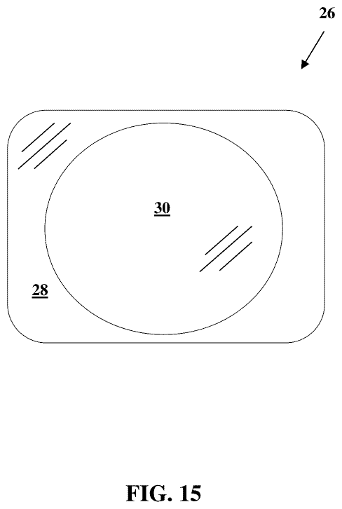

FIG. 15 illustrates the compressing and smoothing tool 26. The compressing and smoothing tool 26 has a flat section 28 and a beveled section 30.

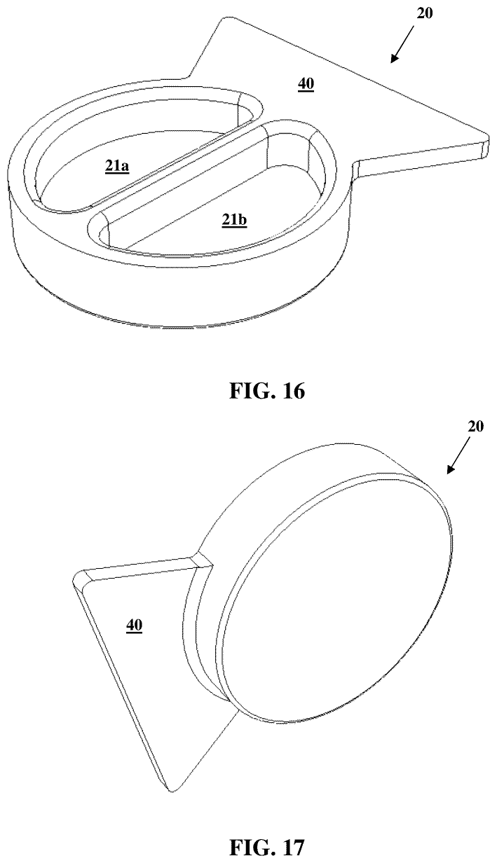

FIG. 16 illustrates an isometric top view of the core mold 20, which is flexible. The core mold 20 has two core cavities 21a and 21b. In addition, the core mold 20 has a handle 40.

FIG. 17 illustrates an isometric bottom view of the core mold 20, which is flexible, with the handle 40.

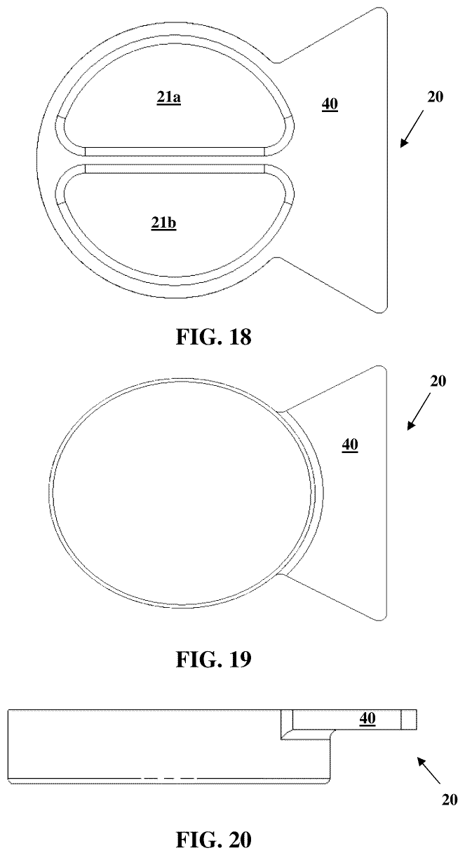

FIG. 18 illustrates a top view of the core mold 20, which is flexible, with two core cavities 21a and 21b. The two core cavities 21a and 21b are configured beside each other. In addition, the handle 40 of the core mold 20 is shown.

FIG. 19 illustrates a bottom view of the core mold 20, which is flexible, with the handle 40.

FIG. 20 illustrates a side view of the core mold 20, which is flexible, with the handle 40.

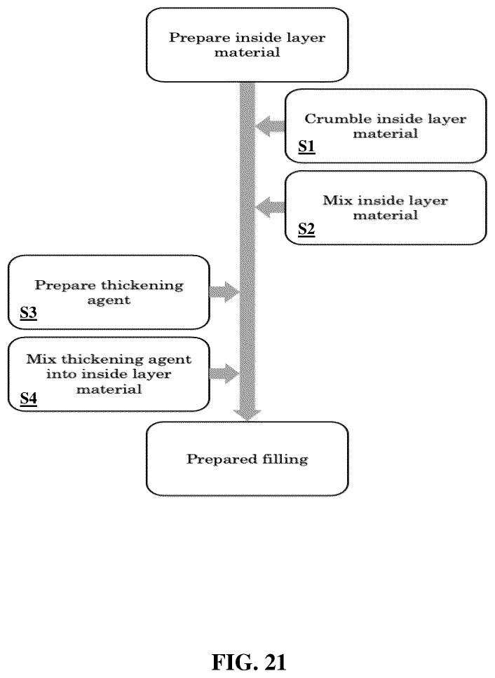

FIG. 21 is a flowchart of an example method for preparing an inside layer material or filling. Step 1 (S1) comprises crumbling the inside layer material. Step 2 (S2) comprises mixing the inside layer material. Step 3 (S3) comprises preparing a thickening agent. Step 4 (S4) comprises mixing the thickening agent into inside layer material.

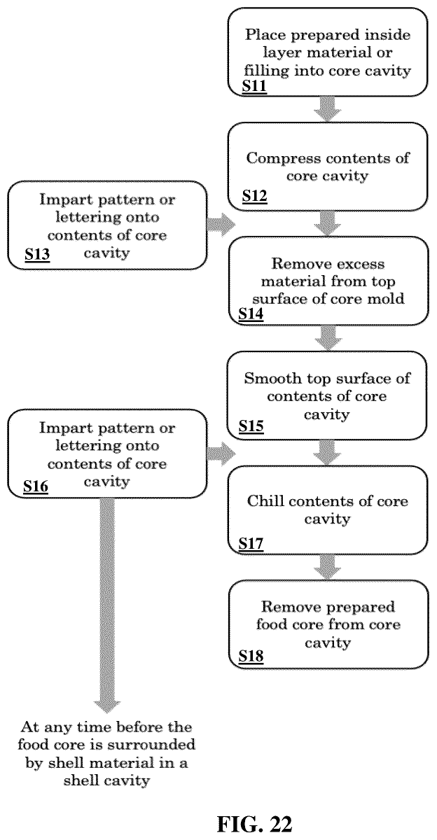

FIG. 22 is a flowchart of an example method for using a core mold 20 to produce a food core. Step 11 (S11) comprises placing the prepared inside layer material or filing into a core cavity 21. Step 12 (S12) comprises compressing the contents of the core cavity 21. Step 13 (S13) comprises imparting a pattern or lettering into the contents of the core cavity 21. Step 14 (S14) comprises removing excess material from the top surface of the core mold. The skilled artisan would understand that S14 may be completed using the compressing and smoothing tool 26. Step 15 (S15) comprises smoothing the top surface of the contents of the core cavity 21. The skilled artisan would understand that S15 may be completed using the compressing and smoothing tool 26. Step 16 (S16) comprises imparting a pattern or lettering into the contents of the core cavity 21. The skilled artisan would understand that S16 may be completed at any time before the food core is surrounded by shell material in the shell cavity 23. Step 17 (S17) comprises chilling the contents of the core cavity 21. Step 18 (S18) comprises removing the prepared food core from the core cavity 21.

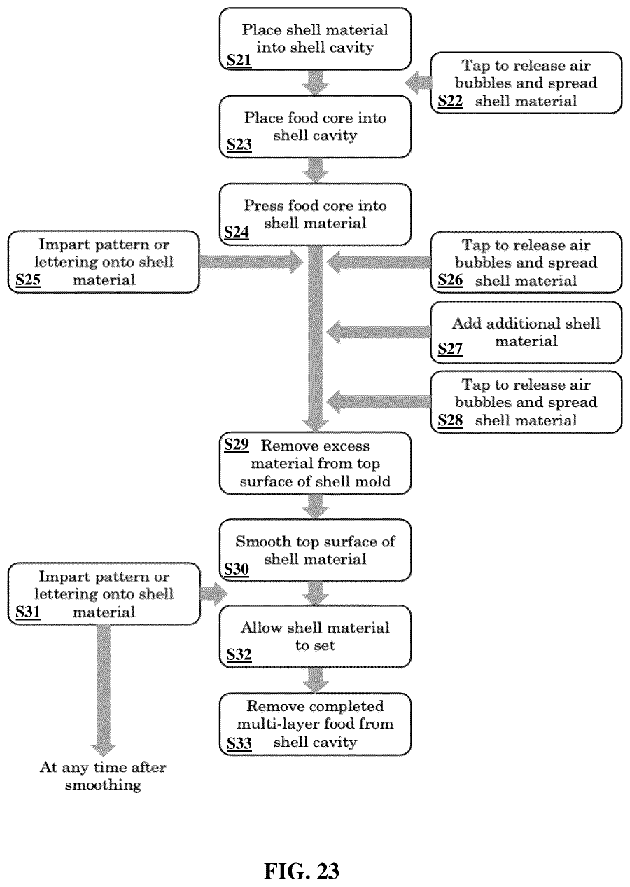

FIG. 23 is a flowchart of an example method for using a shell mold to produce a multi-layer food. Step 21 (S21) comprises placing shell material into the shell cavity 23. Step 22 (S22) comprises the user to tap the shell cavity 23 to release air bubbles and spread shell material. Step 23 (S23) comprises placing the food core into the shell cavity 23. Step 24 (S24) comprises pressing the food core into shell material. Step 25 (S25) comprises imparting a pattern or lettering into the shell material. Step 26 (S26) comprises the user to tap the shell cavity 23 to release air bubbles and spread shell material. Step 27 (S27) comprises adding an additional shell material. Step 28 (S28) comprises the user to tap to release air bubbles and spread shell material. The skilled artisan would understand that S25 to S28 may be present, or alternatively, a user may omit one or more steps of these steps without departing from the teachings of this disclosure. Step 29 (S29) comprises removing excess material from the top surface of the shell mold 22. Step 30 (S30) comprises smoothing the top surface of the shell material. Step 31 (S31) comprises imparting a pattern or lettering into the shell material. The skilled artisan would understand that S31 may occur at any time after smoothing. Step 32 (S32) comprises allowing the shell material to set. Step 33 (S33) comprises removing the completed multi-layer food from the shell cavity.

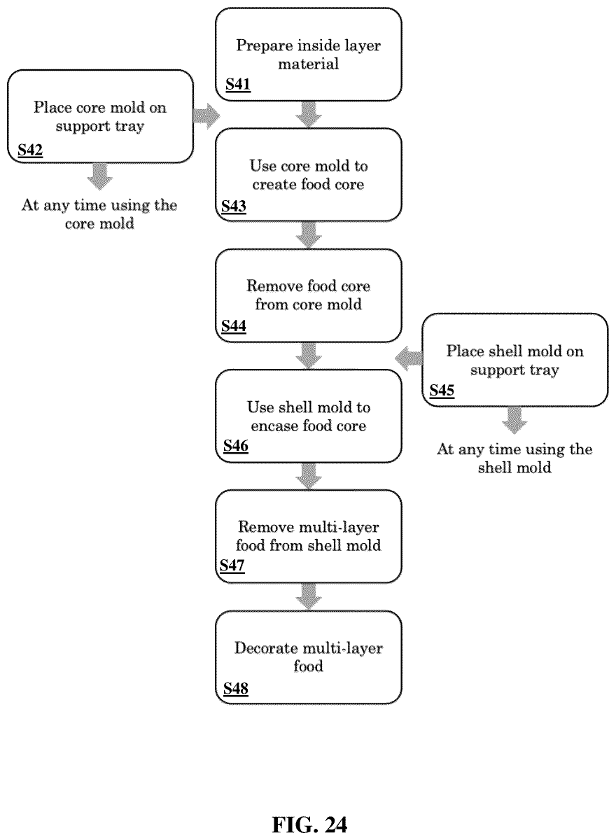

FIG. 24 is a flowchart of an example method for preparing a multi-layered food. Step 41 (S41) comprises preparing the inside layer material. Step 42 (S42) comprises placing the core mold 20 on the support tray 24. The skilled artisan would understand that S42 may occur at any time using the core mold 20. Step 43 (S43) comprises using the core mold 20 to create a food core. Step 44 (S44) comprises removing the food core from the core mold 20. Step 45 (S45) comprises placing the shell mold 22 on the support tray 24. The skilled artisan would appreciate that S45 could occur at any time using the shell mold 22. Step 46 (S46) comprises using the shell mold 22 to encase the food core. Step 47 (S47) comprises removing the multi-layer food from the shell mold 22. Step 48 (S48) comprises decorating the multi-layer food.

Many modifications and variations will be apparent to those of ordinary skill in the art without departing from the scope and spirit of the described examples. The terminology used herein was chosen to best explain the principles of the examples, the practical application or technical improvement over technologies found in the marketplace, or to enable others of ordinary skill in the art to understand the examples disclosed herein.

The invention claimed is:

1. A kit for creating multi-layered food, comprising:
a. a core mold comprising a plurality of core cavities, each core cavity having at least one sidewall and a base that define a first volume dimensioned to receive and mold an inside layer material;
b. a shell mold comprising a plurality of shell cavities, each shell cavity having at least one sidewall and a base that define a second volume, each shell cavity dimensioned to receive a shell material and a food core from one of the plurality of core cavities; and
c. wherein at least one core mold and at least one shell mold are configured to be flexible to allow at least one of the food cores and a completed multi-layered food to be easily removable.

2. The kit of claim 1, wherein at least one of the molds comprises flexible food-grade silicon.

3. The kit of claim 1, wherein the core cavities are configured to receive one or more materials selected from the group consisting of a thickening agent, cake, cookie, brownie, a protein mix, an energy mix, cookie mix, brownie mix, a low-carb high-fat mix, and candy.

4. The kit of claim 1, wherein at least one of the plurality of core cavities and plurality of shell cavities comprises a flexible material configured to allow the completed multi-layered food to have a top surface, a bottom surface, and sides that are perpendicular to the top and bottom surfaces.

5. The kit of claim 1, wherein each of the core cavities has a corresponding shell cavity, wherein each of the core cavities and its respective corresponding shell cavity have the same shape.

6. The kit of claim 5, wherein the shape of at least one of the core cavities and its corresponding shell cavity is a cylinder.

7. The kit of claim 1, wherein:
a. the core mold further comprises a flat surface extending between the core cavities, the flat surface comprising a first material;
b. the sidewalls and base of the core cavities comprise a second material;
c. the shell mold further comprises a flat surface extending between the shell cavities, the flat surface comprising the first material;
d. the sidewalls and base of the shell cavities comprise the second material; and
e. the second material is more flexible than the first material such that the flat surface of the core mold and the shell mold are more rigid than the sidewalls and base of the core cavities and shell cavities.

8. A kit for creating multi-layered food, comprising:
a. a core mold comprising at least one core cavity, the at least one core cavity having a first volume dimensioned to receive a filling to create a food core;
b. a shell mold comprising at least one shell cavity, the at least one shell cavity having a second volume that is the same shape as the first volume, the at least one core cavity dimensioned to be nested within the at least one shell cavity, the at least one shell cavity dimensioned to receive a shell material and one or more food cores;
c. a support tray having a flat surface and being dimensioned to support the core mold and the shell mold, the flat surface configured to provide structural stability at a base of each of the core cavities and shell cavities while the respective filling and shell material set, while the core and shell molds are tapped, and while the core and shell molds are moved; and
d. a tool having a flat surface with a raised portion, the raised portion dimensioned to allow compression and smoothing of the filling in the at least one core cavity, wherein:
i. the tool may be pressed downward with the raised portion laying flush over a top opening of one of the at least one core cavities such that the raised portion compresses the filling in the core cavity; and
ii. the tool may be tilted sideways and scraped across the top opening of one of the at least one core cavities such that the flat surface removes excess material above the top opening of the at least one core cavity.

9. The kit of claim 8, wherein the support tray further comprises one or more indentations in the flat surface, wherein:
a. the number of indentations is equal to the number of core cavities and shell cavities;
b. the core cavities and shell cavities each further comprise a bottom surface, the bottom surfaces each defining a shape;
c. the shape of the indentations being the same as the shape defined by the bottom surfaces of the core cavities and shell cavities; and
d. the one or more indentations are configured to receive the bottom surfaces of the core cavities and shell cavities to prevent the core mold and the shell mold from sliding when either mold is set on the support tray.

10. The kit of claim 9, wherein:
a. each of the one or more core cavities has a first top opening having a first top shape;
b. each of the one or more shell cavities has a second top opening having a second top shape; and
c. the raised portion of the tool has the same shape as the first and second top shape of the top openings.

11. The kit of claim 9, wherein the tool is further configured to allow compression and smoothing of the shell material in the at least one shell cavity, wherein:
a. the tool may be pressed downward with the raised portion laying flush over a top opening of one of the at least one shell cavities such that the raised portion compresses the shell material in the shell cavity; and
b. the tool may be tilted sideways and scraped across the top opening of one of the at least one shell cavities such that the flat surface removes excess material above the top opening of the at least one shell cavity.

12. The kit of claim 9, wherein the tool further comprises at least one gripping surface.

13. The kit of claim 9, further comprising a lid, wherein:
a. the lid is configured to attach to the support tray; and
b. the lid is configured to cover the core mold and the shell mold while the core mold is nested within the shell mold.

14. A method of making multi-layered food, comprising the steps:
a. preparing an inside layer material;
b. adding a thickening agent to the inside layer material to create a filling;
c. placing the filling in a core mold comprising a plurality of core cavities;
d. compressing the filling into the core cavities;
e. removing excess filling from the top of the core cavities;
f. chilling the filling;
g. removing the filling from the core mold to create a plurality of food cores;
h. preparing a shell material;
i. placing the shell material in a shell mold comprising a plurality of shell cavities;
j. placing at least one of the food cores in each of the plurality of the shell cavities such that the shell material surrounds the at least one food cores;
k. allowing the shell material to set; and
l. removing the contents of the plurality of shell cavities to create a completed multi-layered food.

15. The method of claim 14, wherein the inside layer material comprises one or more materials selected from the group consisting of cake, cookie, brownie, a protein mix, an energy mix, cookie mix, brownie mix, a low-carb high-fat mix, and candy.

16. The method of claim 14, wherein the thickening agent comprises one or more materials selected from the group consisting of frosting, custard, cream cheese, coconut oil, almond butter, and peanut butter.

17. The method of claim 14, wherein the weight ratio of thickening agent to inside layer material is at least 2:5 and no more than 4:5.

18. The method of claim 14, wherein the shell material comprises one or more materials selected from the group consisting of chocolate, food coloring, confectionary sprinkles, nuts, and coconut.

19. The method of claim 14, further comprising: settling the contents of each core cavity and the contents of each shell cavity by tapping the sides and top of each core cavity and the sides and top of each shell cavity to release air bubbles and spread the contents of each core cavity and the contents of each shell cavity evenly.

20. The method of claim 14, wherein before allowing the shell material to set, the method further comprises adding additional amounts of the shell material to the shell cavity structure such that the shell material in the shell cavity structure has a top surface, the top surface being flush with a top surface of the shell mold.
